(19) United States
(12) Patent Application Publication
(10) Pub. No.: US 2025/0136767 A1
(43) Pub. Date: May 1, 2025

(54) ULTRASOUND-ASSISTED CARBOXYALKYLATION OF LIGNIN

(71) Applicant: CORPORATION DE L'ÉCOLE POLYTECHNIQUE DE MONTRÉAL, MONTRÉAL (CA)

(72) Inventors: Dalma SCHIEPPATI, Montréal (CA); Daria Camilla BOFFITO, Montréal (CA)

(73) Assignee: CORPORATION DE L'ÉCOLE POLYTECHNIQUE DE MONTRÉAL, MONTRÉAL, QC (CA)

(21) Appl. No.: 18/722,097

(22) PCT Filed: Dec. 20, 2022
(86) PCT No.: PCT/CA2022/051867

§ 371 Date: Jun. 20, 2024

Related U.S. Application Data
(60) Provisional application No. 63/292,422, filed on Dec. 21, 2021.

(51) Int. Cl. C08H 7/00

(52) U.S. Cl. CPC C08H 6/00

(57) ABSTRACT

The present application relates to valorization of lignin products. More specifically, the present application relates to conversion of lignin to added-value products. The present application includes a process for modifying lignin, said process comprising: treating lignin material in a basic aqueous solution to obtain a mixture; submitting the mixture to ultrasonic treatment in the presence of at least one carboxyalkylating agent to depolymerize and carboxyalkylate the lignin to obtain carboxyalkylated oligomeric lignin.

### CROSS-REFERENCE TO RELATED APPLICATIONS

The present application claims the benefit of priority of co-pending U.S. Provisional Patent Application No. 63/292,422, which was filed Dec. 21, 2021, the content of which is incorporated herein by reference in their entirety.

### FIELD

The present application is in the field of valorization of lignin products. More specifically, the present application relates to conversion of lignin to added-value products.

### BACKGROUND

Lignin is the most abundant biopolymer on Earth after cellulose, with a global market of 793.7 million USD that is expected to reach 906.4 million USD by 2025 [1]. Lignin derives from an enzyme-initiated dehydrogenative polymerization of p-coumaryl, coniferyl and sinapyl alcohols [2, 3] and makes up about 25% to 40% of wood [4]. The content of the three different types of cinnamyl alcohols depends on genetic factors [5], environmental [6] and physiological [7] conditions at the time of lignification, and results in the formation of a complex heterogeneous polyphenolic structure that deposits in the cell wall between cellulose, hemi-cellulose and pectin and protects the polysaccharides in the cell wall from microbial degradation. Moreover, as lignin is relatively hydrophobic, it provides the structural stiffness and strength of the stem and it is responsible for conducting water in plants [8].

The pulp and paper industry produces between 40 million tons and 50 million tons of lignin waste every year [9] as lignin represents an obstacle to the process of papermaking. High quality lignin and derivatives are commercially available and converted into a wide variety of added value aromatics such as resins [10] and fertilizers [11]. Lignin derivatives also find application in food-grade products as they are powerful antioxidants whose radical scavenging ability depends on the hydroxyl content, molecular weight and solubility [12].

About 85% of worldwide industrial lignin comes from the Kraft pulping process [13]. This process converts wood into cellulosic pulp and generates a black liquor that is further acidified to separate lignin from hemicellulose and residual inorganics employed in the process [14]. Kraft lignin features poor filterability and solubility in water, and requires a high amount of chemicals for its production. Moreover, the acidification step prevents the totally reduced sulfur (TRS) compounds from evaporating thus yielding a lignin that is not pure and difficult to depolymerize [15]. In order to improve filterability and, therefore, purity, a known process is the LignoForce process in which the black liquor is oxidized prior to acidification. This outputs a lignin that is purer and easier to convert [16]. However, poor water solubility remains a key impediment to Kraft lignin workability, which has limited industrial application [17].

Lignin may also be present in non-negligible quantities in industrial waste, agricultural waste, and the like. It may be advantageous to recover such lignin from waste products.

In general, lignin solubility relates to Hildebrand's solubility parameter, which is a measure of the resistance of intermolecular forces that hold molecules together in the liquid state, and the ability of a solvent to form hydrogen bonds with the polar groups of lignin [18].

The cause of lignin poor solubility ascribes to its folded structure: the polar groups responsible for hydrogen bonding are sterically hindered. The modification of the outer groups of lignin with bigger and/or more polar groups facilitates its dispersion in water and other polar solvents [19, 20]. Hydroxymethylation and oxidation yielded modified lignins with chelating capacity 73% higher than the original Organosolv lignins but solubility did not improve by the same extent [20]. Carboxymethylation [21, 22, 23] and sulfonation [24, 25, 26] increased lignin water solubility and enabled the biopolymer to act as dispersant. Nonetheless, lignin modification requires rigorous reaction conditions and purification steps thus rendering the production on a large scale uneconomic and burdensome.

Many researchers also focused on the depolymerization of lignin to recover phenols, alkylphenols, aromatic acids [27, 28, 29, 30] and added value aldehydes such as vanillin [31, 32]. Lignin features a high degree of complexity and its depolymerization becomes more tangled at high temperature as it follows a free-radical reaction pathway [33, 34]. This poses non-negligible hurdles to the process. In fact, many reactive intermediates originate from the rupture of β-O-4 linkages as it is the weakest bond with an energy from 170.6 kJ mol⁻¹ to 273.2 kJ mol^{-1 [35, 36}]. C-centered radicals recombine to originate tar and coke by forming new strong C—C bonds [37], whereas alkaline depolymerization cleaves aryl-ether bonds thus increasing the content of phenolic hydroxy groups [38], which promptly react unless the oligomerization process is topped with an external reagent (e.g. capping agent).

Typically, boric acid acts as a capping agent to cap and protect the highly reactive substituted phenols to form borate esters and increase the oil yield from 11.5% to 52% during hydrothermal alkaline treatment at a pH of 13 [39]. Despite the utility of capping agents in quenching lignin depolymerization, they require additional work-up steps during the production of added value aromatics. In fact, the oil requires additional separation, uncapping and purification stages, which make the large-scale manufacture economically impracticable.

As such, there is need to provide improved methods for conversion of lignin, which are quicker, easier, less expensive, controllable and form high-value derivatives for valorization of lignin.

### SUMMARY

It has been surprisingly shown herein that processes of the present application provide for high-value lignin derivatives with improved properties. The processes of the present application further provide for rapid, tunable and efficient conversion of lignin. Comparable processes did not display the same properties, highlighting the surprising results obtained with the processes of the application.

Accordingly, the present application includes a process for modifying lignin, said process comprising: treating lignin material in a basic aqueous solution to obtain a mixture; submitting the mixture to ultrasonic treatment in the presence of at least one carboxyalkylating agent to depolymerize and carboxyalkylate the lignin to obtain carboxyalkylated oligomeric lignin.

The present application further includes a process for the manufacture of a biodispersant, said process comprising: submitting lignin material to ultrasonic treatment in the presence of a basic aqueous solution and at least one carboxyalkylating agent to depolymerize and carboxyalkylate the lignin to obtain carboxyalkylated oligomeric lignin; recovering the carboxyalkylated oligomeric lignin as the biodispersant.

In some embodiments, the lignin material is softwood-derived lignin, kraft lignin, organosolv lignin, LignoForce™ lignin, LignoBoost™ lignin, hardwood-derived lignin, lignin-containing agricultural waste, lignin-containing industrial waste, or mixtures thereof. In some embodiments, the lignin material has a molecular weight of about 5 kDa to about 30 kDa.

In some embodiments, the basic aqueous solution comprises NaOH, KOH, LiOH, Ca(OH)₂, or mixtures thereof. In some embodiments, the basic aqueous solution has a concentration from about 0.2M to about 3M.

In some embodiments, the concentration of raw lignin material in the basic aqueous solution is from about 10 g/L to about 30 g/L

In some embodiments, the treating is conducted for about 10 to about 90 minutes. In some embodiments, the treating is conducted at a temperature of about 35° C. to about 90° C. In some embodiments, treating comprises mixing, heating, or both.

In some embodiments, the at least one carboxyalkylating agent is selected from an alkali and alkaline earth metal salt of a C₂-C₁₀ halocarboxylic acid.

In some embodiments, the alkali and alkaline earth metal salt is selected from sodium salt, potassium salt, lithium salt, calcium salt, magnesium salt, and mixtures thereof.

In some embodiments, the C₂-C₁₀ halocarboxylic acid is a chlorocarboxylic acid, a bromocarboxylic acid, an iodocarboxylic acid, or a fluorocarboxylic acid.

In some embodiments, the at least one carboxyalkylating agent is selected from sodium chloroacetate, sodium bromoacetate, sodium iodoacetate, sodium fluoroacetate, potassium chloroacetate, potassium bromoacetate, potassium iodoacetate, potassium fluoroacetate, sodium chloropropanoate, sodium bromopropanoate, sodium iodopropanoate, sodium fluoropropanoate, potassium chloropropanoate, potassium bromopropanoate, potassium iodopropanoate, potassium fluoropropanoate, sodium chlorobutanoate, sodium bromobutanoate, sodium iodobutanoate, sodium fluorobutanoate, potassium chlorobutanoate, potassium bromobutanoate, potassium iodobutanoate, potassium fluorobutanoate, sodium chloropentanoate, sodium bromopentanoate, sodium iodopentanoate, sodium fluoropentanoate, potassium chloropentanoate, potassium bromopentanoate, potassium iodopentanoate, and potassium fluoropentanoate.

In some embodiments, the molar ratio of carboxyalkylating agent to lignin material is from about 1 to 15.

In some embodiments, the ultrasonic treatment comprises applying ultrasound at a frequency of about 20 kHz to about 100 kHz.

The process of any one of claims 1 to 16, wherein the ultrasonic treatment is conducted for about 10 minutes to about 90 minutes. In some embodiments, the ultrasonic treatment is conducted at a temperature of about 35° C. to about 90° C.

In some embodiments, the depolymerization comprises selective breakage of β-O-4′ linkages of the lignin.

In some embodiments, the carboxyalkylated oligomeric lignin has a molecular weight from about 0.4 kDa to about 2 kDa.

In some embodiments, the processes of the present application further comprise at least one additional processing selected from neutralization, separation, purification, dialysis, drying, to provide purified carboxyalkylated oligomeric lignin.

In some embodiments, the carboxyalkylated oligomeric lignin has an increased solubility of about 10% to about 24% compared to the solubility of the starting lignin material. In some embodiments, the carboxyalkylated oligomeric lignin has an increased charge density of about 15% to about 24% compared to the charge density of the starting lignin material.

The present application also includes a process for selective breakage of β-O-4′ linkages of lignin, said process comprising: treating raw lignin material in a basic aqueous solution at a temperature of about 35° C. to about 90° C. to obtain a mixture; submitting the mixture to ultrasonic treatment at a frequency of about 20 KHz to about 100 kHz in the presence of at least one carboxymethylating agent to depolymerize and carboxymethylate the lignin to obtain carboxymethylated oligomeric lignin; wherein the basic aqueous solution comprises NaOH, KOH, LiOH, Ca(OH)₂, or mixtures thereof; wherein the carboxymethylating agent is selected from sodium chloroacetate, sodium bromoacetate, sodium iodoacetate, sodium fluoroacetate, potassium chloroacetate, potassium bromoacetate, potassium iodoacetate and potassium fluoroacetate.

Further provided is a carboxyalkylated oligomeric lignin obtained by the process of the present application.

Further included is a carboxymethylated oligomeric lignin obtained by the process of claim 24.

In some embodiments, the carboxyalkylated oligomeric lignin or the carboxymethylated oligomeric lignin of the present application is for use as a dispersing agent, a stabilizing agent, a thickener, a flocculant, an anticoagulant or an adsorbent.

The present application further provides use of the carboxyalkylated oligomeric lignin or the carboxymethylated oligomeric lignin obtained by the process of the present application as a dispersing agent, a stabilizing agent, a thickener, a flocculant, an anticoagulant or an adsorbent.

The present application further includes use of ultrasonic treatment for selective breakage of β-O-4′ linkages of lignin.

The present application also provides use of ultrasonic treatment, at least one carboxyalkylating agent and a base in the manufacture of a dispersing agent, a stabilizing agent, a thickener, a flocculant or an adsorbent.

The present application further provides use of ultrasonic treatment, at least one carboxyalkylating agent and a base for depolymerization and carboxyalkylation of lignin.

Also included is a dispersant comprising the carboxyalkylated oligomeric lignin or the carboxymethylated oligomeric lignin obtained by the process of the present application.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows a graph of dispersion ability of unmodified lignin and CML (CBU3), according to exemplary embodiments of the present application.

FIGS. 2A and 2B show a graphs of dispersion ability of CMLs obtained with the comparative standard method (CA2, CB2) and with ultrasonic treatment (CAU3, CAUT1, CBU3, CBUT3) for FIG. 2A: lignin A, and FIG. 2B: lignin B, according to exemplary embodiments of the present application.

FIG. 3 shows a graph of dispersion ability of a comparative dispersant (DOSS) and CMLs obtained with ultrasonic treatment (CAU3, CBU3, CBUT3), according to exemplary embodiments of the present application.

FIG. 4 shows a graph of dispersion ability of CMLs obtained with ultrasonic treatment (CAU1, CAU2, CAU3, CAUT3), according to exemplary embodiments of the present application.

FIG. 5 shows a graph of weight loss of unmodified lignins (lignins A and B) and CMLs obtained with ultrasonic treatment (CAU3, CBU3), according to exemplary embodiments of the present application.

FIG. 6 shows a graph of weight loss of CMLs obtained with ultrasonic treatment (CAU3, CBU3, CBUT3), according to exemplary embodiments of the present application.

FIG. 7 shows FT-IR spectra of an unmodified lignin (lignin B) and CML (CBU3), according to exemplary embodiments of the present application.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “compound of the application” or “compound of the present application” and the like as used herein refers to compounds made according to process of the application.

The term “composition of the application” or “composition of the present application” and the like as used herein refers to a composition comprising one or more compounds of the application.

The term “suitable” as used herein means that the selection of the particular composition or conditions would depend on the specific steps to be performed, the identity of the components to be transformed and/or the specific use for the compositions, but the selection would be well within the skill of a person trained in the art.

The term “lignin” as used herein refers to a class of complex oxygen-containing organic polymer formed by the heterogenous cross-linking of various phenolic precursors, and is naturally derived from plants, mostly wood.

The term “depolymerization” as used herein generally means the process of converting a polymer into smaller molecules, such as smaller polymers, oligomers or monomers, which involves breaking down the bonds connecting monomer blocks in the polymer chain without damaging monomers themselves.

The term “carboxymethylation” as used herein means the process of functionalizing an alcohol with a carboxymethyl group.

The term “oligomer” as used herein refers to a molecule that consists of a few similar or identical repeating units, as opposed to a polymer which is usually understood to have a large number of units, possibly hundreds or thousands.

The present description refers to a number of chemical terms and abbreviations used by those skilled in the art. Nevertheless, definitions of selected terms are provided for clarity and consistency.

The term “aq.” as used herein refers to aqueous.

The term “Da” or “kDa” as used herein refers to Dalton or kilo Dalton unit.

The term “M” as used herein refers to the molar concentration, or molarity, where 1M corresponds to 1 mol/L.

The term “rpm” as used herein refers to revolution per minute.

The term “MW” as used herein refers to molecular weight.

The term “HPLC” used herein refers to high performance liquid chromatography.

The term “FTIR” as used herein refers to Fourier-Transform Infrared spectroscopy.

The term “GPC” as used herein refers to gel permeation chromatography.

The term “PTFE” as used herein refers to polytetrafluoroethylene.

The term “TGA” as used herein refers to thermogravimetric analyzer.

The term “PDA” as used herein refers to photometric dispersion analyzer.

The term “DC” as used herein refers to direct component, which refers to the average transmitted light intensity.

The term “LED” as used herein refers to light-emitting diode.

The term “PVSK” as used herein refers to polyvinylsulfuric acid potassium salt.

The term “THF” as used herein refers to tetrahydrofuran.

The term “SCA” as used herein refers to sodium chloroacetate.

The term “DOSS” as used herein refers to dioctyl sodium sulfosuccinate.

The term “CML” as used herein refers to carboxymethylated lignin.

The terms “CA” and “CB” as used herein refer to carboxymethylated lignin (control samples) for exemplary lignins A or B. Additionally, “CAU” and “CBU” refer to ultrasonically carboxymethylated lignin and “CAUT” and “CBUT” additionally with temperature control, for exemplary lignins A or B.

### II. Process of the Application

It has been surprisingly shown herein that processes of the present application provide for high-valued lignin derivatives with improved properties. The processes of the present application further provide for rapid, tunable and efficient conversion of lignin. Comparable processes did not display the same properties, highlighting the surprising results obtained with the processes of the application.

Accordingly, the present application includes a process for modifying lignin, said process comprising: treating lignin material in a basic aqueous solution to obtain a mixture; submitting the mixture to ultrasonic treatment in the presence of at least one carboxyalkylating agent to depolymerize and carboxyalkylate the lignin to obtain carboxyalkylated oligomeric lignin.

The present application further includes a process for the manufacture of a biodispersant, said process comprising: submitting lignin material to ultrasonic treatment in the presence of a basic aqueous solution and at least one carboxyalkylating agent to depolymerize and carboxyalkylate the lignin to obtain carboxyalkylated oligomeric lignin; and recovering the carboxyalkylated oligomeric lignin as the biodispersant.

In some embodiments, the lignin material (starting lignin material) is softwood-derived lignin, kraft lignin, organosolv lignin, LignoForce™ lignin, LignoBoost™ lignin, hardwood-derived lignin, lignin-containing agricultural waste, lignin-containing industrial waste, or mixtures thereof. In some embodiments, a skilled person would appreciate that the process of the present application is applicable to any lignin-containing material from which it may be desirable to recover the lignin by modifying the same.

In some embodiments, the starting lignin material has a molecular weight of about 5 kDa to about 30 kDa. In some embodiments, the starting lignin material has a molecular weight of about 5 kDa to about 20 kDa, or about 5 kDa to about 10 kDa.

In some embodiments, the basic aqueous solution comprises NaOH, KOH, LiOH, Ca(OH)₂, or mixtures thereof. In some embodiments, the basic aqueous solution has a concentration from about 0.2 M to about 3 M. In some embodiments, the basic aqueous solution has a concentration from about 0.5 M to about 2.5 M, or about 1 M to about 2 M, or about 1.5 M. A skilled person would appreciate that the nature of the base and its concentration may be selected based on the type of starting lignin material and on its initial molecular weight. This would be well within the purview of the skilled person in the art.

In some embodiments, the concentration of raw lignin material in the basic aqueous solution is from about 10 g/L to about 30 g/L. In some embodiments, the concentration of raw lignin material in the basic aqueous solution is from about 12 g/L to about 25 g/L, or about 15 g/L to about 20 g/L.

In some embodiments, the treating is conducted for about 10 to about 90 minutes. In some embodiments, the treating is conducted for about 20 to about 75 minutes, or about 30 to about 60 minutes.

In some embodiments, the treating is conducted at a temperature of about 35° C. to about 90° C. In some embodiments, the treating is conducted at a temperature of about 40° C. to about 80° C., or about 40° C. to about 60° C.

In some embodiments, treating comprises mixing the mixture, heating, or any treatment that may assist in completion of the lignin modification reaction.

In some embodiments, the at least one carboxyalkylating agent is selected from an alkali and alkaline earth metal salt of a C₂-C₁₀ halocarboxylic acid. It will be appreciated that the selected carboxyalkylating agent will depend on the upper temperature limit of the method such that as its melting temperature is below said upper temperature.

In some embodiments, the alkali and alkaline earth metal salt is selected from sodium salt, potassium salt, lithium salt, calcium salt, magnesium salt, and mixtures thereof. In some embodiments, the C₂-C₁₀ halocarboxylic acid is a chlorocarboxylic acid, a bromocarboxylic acid, an iodocarboxylic acid, or a fluorocarboxylic acid.

In some embodiments, the at least one carboxyalkylating agent is selected from sodium chloroacetate, sodium bromoacetate, sodium iodoacetate, sodium fluoroacetate, potassium chloroacetate, potassium bromoacetate, potassium iodoacetate, potassium fluoroacetate, sodium chloropropanoate, sodium bromopropanoate, sodium iodopropanoate, sodium fluoropropanoate, potassium chloropropanoate, potassium bromopropanoate, potassium iodopropanoate, potassium fluoropropanoate, sodium chlorobutanoate, sodium bromobutanoate, sodium iodobutanoate, sodium fluorobutanoate, potassium chlorobutanoate, potassium bromobutanoate, potassium iodobutanoate, potassium fluorobutanoate, sodium chloropentanoate, sodium bromopentanoate, sodium iodopentanoate, sodium fluoropentanoate, potassium chloropentanoate, potassium bromopentanoate, potassium iodopentanoate, and potassium fluoropentanoate.

In some embodiments, the molar ratio of carboxyalkylating agent to lignin material is from about 1 to 15. In some embodiments, the molar ratio of carboxyalkylating agent to lignin material is from about 3 to 12, or about 5 to 10.

In some embodiments, the ultrasonic treatment comprises applying ultrasound at a frequency of about 20 kHz to about 100 kHz, or about 20 kHz to 90 kHz, or about 30 kHz to about 80 KHz.

In some embodiments, the ultrasonic treatment comprises delivering ultrasound waves through a surface of less than 10 cm², such as from about 0.1 cm² to about 10 cm² or from about 1 cm² to about 10 cm² or from about 5 cm² to about 10 cm² with a nominal power of up 5 kW, such as from about 0.5 kW to about 5 kW, or from about 1 kW to about 5 kW or from about 2.5 kW to about 5 kW. In some embodiments, the ultrasonic treatment comprises delivering ultrasound waves through a larger surfaces with a nominal power up to 16 kW, such as from about 5 kW to about 16 kW, about 6 kW to about 16 kW, or from about 10 kW to about 16 kW or from about 12 kW to about 15 kW. In some embodiments, the larger surfaces are from about 2.5 cm² to about 50 cm² for axially emitting sonotrodes and about 2.5 cm² to about 450 cm or about 10 cm² to about 450 cm² for radially emitting sonotrodes. In some embodiments, the delivery can be at multiple locations in the ultrasound vessel. In some embodiments, the ratio of power by surface for small emitters is from about 0.05 to about 50 kW/cm², or from about 1 to about 50 kW/cm² or about 5 to about 50 kW/cm², and for larger emitters, from about 6.4 to about 90 kW/cm² or from about 15 to about 90 kW/cm², or from about 25 to about 90 kW/cm².

In some embodiments, the ultrasonic treatment is conducted for about 10 minutes to about 90 minutes. In some embodiments, the ultrasonic treatment is conducted for about 20 to about 75 minutes, or about 30 to about 60 minutes.

In some embodiments, the ultrasonic treatment is conducted at a temperature of about 35° C. to about 90° C. In some embodiments, the ultrasonic treatment is conducted at a temperature of about 40° C. to about 80° C., or about 40° C. to about 60° C.

In some embodiments, the depolymerization comprises selective breakage of β-O-4′ linkages of the lignin. Without being bound to theory, this selective depolymerization is advantageous as the cleavage of such aryl ether bonds originates alcohol functionalities that are prone to carboxyalkylation.

In some embodiments, the carboxyalkylated oligomeric lignin has a molecular weight from about 0.4 kDa to about 2 kDa. In some embodiments, the carboxyalkylated oligomeric lignin has a molecular weight from about 0.6 kDa to about 1.8 kDa, or about 0.8 kDa to about 1.5 kDa.

In some embodiments, the process further comprises at least one additional processing selected from neutralization, separation, purification, dialysis, drying, to provide purified carboxyalkylated oligomeric lignin. For example, neutralization of the mixture may occur through the addition of a mineral acid to quench the reaction as well as phase out the modified lignin so that it can be further separated. Separation of lignin from the liquid media may be achieved through centrifugation. Modified lignin may be purified via multiple washes with water and organic solvents and then dialyzed with membranes, for example cellulose acetated membranes, in water to remove unreacted reagents and by-products trapped in the lignin macromolecule. In some embodiments, drying is conducted to allow for further characterization of the carboxyalkylated lignin. For example, products are dried in an oven and then stored at room temperature prior to analysis.

In some embodiments, the carboxyalkylated oligomeric lignin has an increased solubility of about 10% to about 24% compared to the solubility of the starting lignin material. In some embodiments, the carboxyalkylated oligomeric lignin has an increased solubility of about 10% to about 20%, or about 12% to about 18%.

In some embodiments, the carboxyalkylated oligomeric lignin has an increased charge density of about 15% to about 24% compared to the charge density of the starting lignin material. In some embodiments, the carboxyalkylated oligomeric lignin has an increased charge density of about 16% to about 22%, or about 18% to about 20%.

The present application further provides a process for selective breakage of β-O-4′ linkages of lignin, said process comprising: treating raw lignin material in a basic aqueous solution at a temperature of about 35° C. to about 90° C. to obtain a mixture; submitting the mixture to ultrasonic treatment at a frequency of about 20 kHz to about 100 kHz in the presence of at least one carboxymethylating agent to depolymerize and carboxymethylate the lignin to obtain carboxymethylated oligomeric lignin; wherein the basic aqueous solution comprises wherein the carboxymethylating agent is selected from sodium chloroacetate, sodium bromoacetate, sodium iodoacetate, sodium fluoroacetate, potassium chloroacetate, potassium bromoacetate, potassium iodoacetate and potassium fluoroacetate.

### III. Compositions of the Application

The processes of the application have been shown to provide high-valued lignin derivatives with improved properties. The processes of the present application further provide for rapid, tunable and efficient conversion of lignin.

Accordingly, the present application includes a carboxyalkylated oligomeric lignin obtained by the process of the present application.

Also provided is a carboxymethylated oligomeric lignin obtained by the process of the present application.

Further provided is a dispersant comprising the carboxyalkylated oligomeric lignin or the carboxymethylated oligomeric lignin obtained by the process of the present application.

### IV. Uses of the Application

The processes of the application have been shown to provide high-valued lignin derivatives with improved properties. The processes of the present application further provide for rapid, tunable and efficient conversion of lignin.

The carboxyalkylated oligomeric lignin or the carboxymethylated oligomeric lignin of the present application may be used as a dispersing agent, a stabilizing agent, a thickener, a flocculant, an anticoagulant or an adsorbent.

Accordingly, the present application includes the use of the carboxyalkylated oligomeric lignin or the carboxymethylated oligomeric lignin obtained by the process of the present application as a dispersing agent, a stabilizing agent, a thickener, a flocculant, an anticoagulant or an adsorbent.

The present application further includes use of ultrasonic treatment for selective breakage of β-O-4′ linkages of the lignin.

Further provided is the use of ultrasonic treatment, at least one carboxyalkylating agent and a base in the manufacture of a dispersing agent, a stabilizing agent, a thickener, a flocculant or an adsorbent.

Also included is the use of ultrasonic treatment, at least one carboxyalkylating agent and a base for depolymerization and carboxyalkylation of lignin.

### EXAMPLES

The following non-limiting examples are illustrative of the present application.

### General Methods

In the present examples, two LignoForce Kraft softwood lignins were depolymerized by breaking the β-O-4 linkages with ultrasound and subsequently capping the reactive hydroxy groups generated with a carboxymethylating agent, sodium chloroacetate (SCA), to produce biodispersants. Optimal operative conditions for the overall intensification of the ultrasound-assisted carboxymethylation process were assessed to produce biodispersants.

### Lignins

An exemplary ultrasound assisted carboxymethylation reaction (Scheme 1) according to the present application was conducted to produce biodispersants on two different lignins manufactured and characterized by FPInnovation via the LignoForce process. Lignin A and lignin B are both softwood lignins but the former is in free hydrogen form and the latter is in sodium salt form (Table 1).

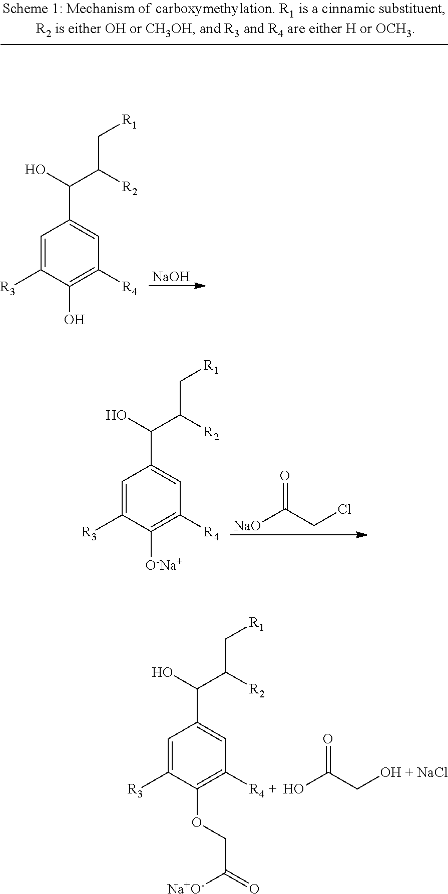

TABLE 1
Characterization of lignins

| Analysis | Lignin A | Lignin B |
|---|---|---|
| Average molecular weight (Da) | 6870 | 5147 |
| Ash (%) | 0.83 | 22.3 |
| Organics (%) | 99.17 | 77.7 |
| Acid-insoluble lignin (%) | 93.32 | 71.39 |
| Acid-soluble lignin (%) | 1.84 | 3.45 |
| Sulfur content (%) | 1.52 | 2.09 |
| Sodium content (%) | 0.20 | 7.51 |

### Carboxymethylation

For all the experiments, the lignin (A or B) concentration was 16.7 g/L as the optimal value for carboxymethylation of Kraft lignin [23]. Lignin dissolved under stirring at 150 rpm in 100 mL of sodium hydroxide (NaOH, pellets, ACS, Fisher Scientific) 1.5 M aqueous solution.

In the case of standard carboxymethylation (control samples-no ultrasound, sample code CA # or CB #), after lignin complete dissolution, a heating plate warmed the solution to 40° C. and sodium chloroacetate was added (98%, Alfa Aesar) according to the design of experiments (DOE) (Table 2). The reaction mixture was maintained at 40° C. and 150 rpm, stirring for 4 h. Successively, the reaction mixture was cooled to room temperature and H₂SO₄ 1 M was added to neutralize the mixture to pH 7. Cellulose acetate membranes with a cut-off of 1000 Da dialyzed the carboxymethylated samples for 48 h to remove unreacted NaOH and SCA, glycolic acid, and NaCl (Scheme 1). Samples were then dried at 105° C. for 36 h and stored in a dry and sealed vials until further use.

The preparation and work up of carboxymethylated lignin (CML) under ultrasonic irradiation followed the same procedure abovementioned but after the complete dissolution of lignin, a 750 W nominal power ultrasonic processor from Sonics & Materials Inc. and a probe with 13 mm diameter replaceable tip sonicated the reaction mixture for 30 min. Ultrasound-assisted carboxymethylation occurred in i) a 150 mL glass Becher (sample code CAU # or CBU #) without temperature control and in ii) a thermostatic 150 mL glass Becher (sample code CLUT #) in which water recirculated to maintain the temperature at 40° C.

TABLE 2
Design of experiments

| | | SCA/lignin | US power | Temperature |
|---|---|---|---|---|
| Test code | Lignin | (mol mol⁻¹) | (W) | (° C.) |
| CA1 | A | 3 | — | 40 |
| CA2 | A | 6 | — | 40 |
| CA3 | A | 12 | — | 40 |
| CAU1 | A | 3 | 20 | 70-75 |
| CAU2 | A | 6 | 20 | 70-75 |
| CAU3 | A | 12 | 20 | 70-75 |
| CAUT1 | A | 3 | 20 | 40 |
| CAUT2 | A | 6 | 20 | 40 |
| CAUT3 | A | 12 | 20 | 40 |
| CB1 | B | 3 | — | 40 |
| CB2 | B | 6 | — | 40 |
| CB3 | B | 12 | — | 40 |
| CBU1 | B | 3 | 20 | 70-75 |
| CBU2 | B | 6 | 20 | 70-75 |
| CBU3 | B | 12 | 20 | 70-75 |
| CBUT1 | B | 3 | 20 | 40 |
| CBUT2 | B | 6 | 20 | 40 |
| CBUT3 | B | 12 | 20 | 40 |

### Molecular Weight Determination

An UltiMate™ 3000 HPLC system from Thermo Scientific was used to determine the molecular weight (MW) of lignin and CMLs upon calibration with polystyrene standards (SL-105, Shodex). Lignin and CMLs are partially or insoluble in tetrahydrofuran (THF). Therefore, 2.5 mL of a 8:92 (v/v) acetyl bromide (for synthesis, Merck) to acetic acid (Reagent Plus™, ≥99%) mixture acetobrominated 0.01 g of product at 50° C. for 2 h under mild stirring prior to GPC analysis to improve solubility. The excess of acetyl bromide and acetic acid solution was removed under reduced pressure through a rotary evaporator. Samples were dried in an oven at 105° C. overnight, and prior to analysis 5 mL of THF (with 0.025% butylated hydroxytoluene as stabilizer, Fisher Chemical) was added to dissolve the samples. Eventually, the undissolved solid particulates were removed with PTFE syringe filters (13 mm diameter and 0.2 μm pore size, Fisher Scientific). The samples were eluted with THE in isocratic mode at a flowrate of 1 mL/min and 28° C. in three polystyrene-divinylbenzene packed columns from Shodex: KF-804L, KF-803L, and KF-802. A KF-G filter guarded the columns upstream.

### FT-IR Attenuated Total Reflection Analysis (ATR)

A Thermo Scientific Nicolet iS5 Fourier-transform infrared (FTIR) spectrometer with an ATR iD7 accessory was used to assess the functional groups of lignin and CMLs. Samples were dried in an oven at 105° C. for 24 h prior to analysis. The samples were scanned with a single beam 100 times with a resolution of 2 cm⁻¹ in a spectral range from 3600 cm⁻¹ to 600 cm⁻¹.

### Thermogravimetric Analysis

A Q50 thermogravimetric analyzer (TGA) from TA Instruments was used to determine the weight loss of the samples with respect to temperature variation at a nitrogen steady flow rate of 40 mL/min with a ramp of 10° C./min up to 780° C.

### Photometric Dispersion Analysis

A photometric dispersion analyzer PDA 3000 from Rank Brothers Ltd was used to assess the dispersion capability of CMLs. 150 mL of a 4 g/L aqueous kaolin clay slurry was agitated with a magnetic stirrer at 300 rpm. The slurry was withdrawn at a constant flow rate of 0.5 mL/min via a syringe pump through a 1 mm internal diameter tube that fits in the slot between the light source and the photodetector. Once the output voltage (DC), which is a measure of the average transmitted light intensity through the suspension [40], stabilized, 60 mL of alkaline aqueous solution (pH 11) containing 0.15 g of lignin or CML was added. The dispersion process was monitored by the PDA for 1000 s at a LED current of 1.65 mA and LED drive of 175. The dispersion capability of the samples was then compared with that of dioctyl sulfosuccinate sodium salt (DOSS, Acros, 96%), a common dispersant.

### Charge Density and Solubility

0.2 g of each sample was suspended in deionized water, which incubated for 1 h at 30° C. in a water bath shaker at 150 rpm. After incubation, samples were centrifuged at 1000 rpm for 10 min. The supernatant was used in a Mutek PCD 04 particle charge detector to determine the solubility and charge density of carboxymethylated lignins upon polyelectrolyte titration with a PVSK standard solution (0.005 M).

### Results

### Dispersion Tests and Molecular Weight

The photometric dispersion ability (D^{v} and D^{h}) of carboxymethylated lignins was compared with their average MWs and fragmentation pattern (F^{h}) obtained with gel permeation chromatography. Specifically, carboxymethylated samples were ranked from I to III (best to worst D^{v}) within the same group of reaction type (C, CU or CUT) obtained with three different SCA/ligin ratio and samples derived from lignin A and B were compared under the same conditions in terms of dispersion ability and fragmentation degree (D^{h} and F^{h}) (Table 3).

TABLE 3
Comparison of carboxymethylated lignins in terms of
dispersion ability (D^{h}) and fragmentation (F^{h}).

| | |
|---|---|
| A-CMLs | B-CMLs |

| D^{v} | Sample | D^{h} | F^{h} | Sample | D^{v} |
|---|---|---|---|---|---|
| II | CA1 | >> | − | CB1 | III |
| I | CA2 | >> | − | CB2 | I |
| III | CA3 | < | − | CB3 | II |
| II | CAU1 | >> | < | CBU1 | II |
| III | CAU2 | >> | < | CBU2 | III |
| I | CAU3 | = | = | CBU3 | I |
| I | CAUT1 | > | > | CBUT1 | III |
| II | CAUT2 | < | > | CBUT2 | II |
| III | CAUT3 | << | << | CBUT3 | I |

^{h}Horizontal comparison
^{v}Vertical comparison in group of three
“>>” and “>” stand for better, and slightly better.
“=” indicates equivalent results.
“I” ranks best performance and “III” ranks worst performance in term of dispersion (Dv) within the same reaction type group.

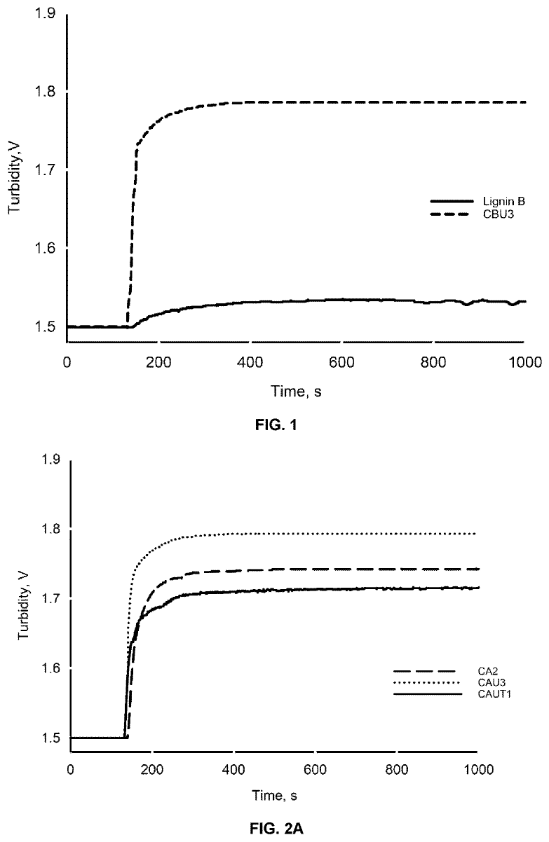

All CMLs samples, whether prepared with the standard method or ultrasound, dispersed the kaolin clay water slurry and the untreated lignins did not (FIG. 1).

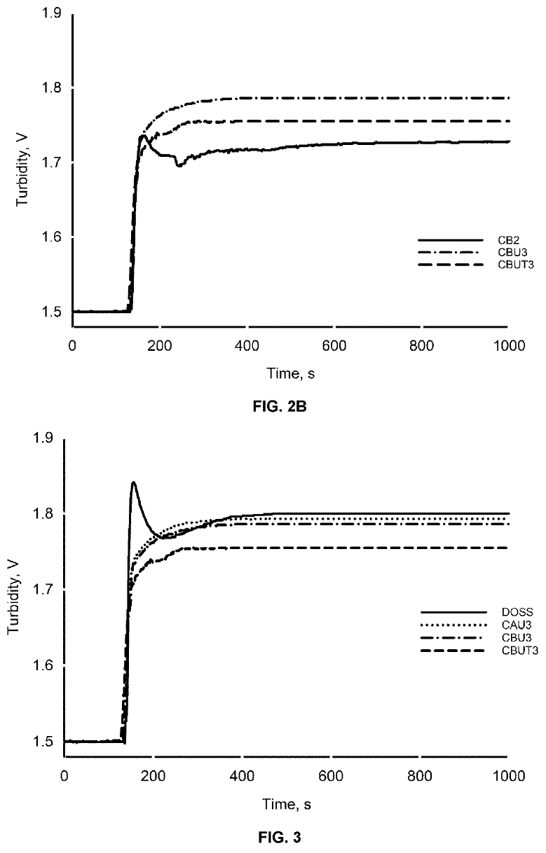

The performance of the CMLs produced with ultrasound was higher than that of CML obtained with the standard method (FIG. 2). However, some samples prepared without controlling the temperature had lower PDA than samples produced with the standard method (FIG. 2A).

CMLs produced with the highest SCA/lignin ratio under ultrasonic irradiation without thermal control, namely CAU3 and CBU3, had the highest dispersion ability among all the CML samples. They dispersed the clay by the same extent as DOSS but more efficiently. In fact, the DC of DOSS reached a maximum but then it decreased by 20.6% to increase again by 8.8% over 150 s. CAU3 and CBU3, instead, dispersed the system immediately without fluctuations (FIG. 3).

Lignin B has a lower molecular weight than lignin A (Table 1) and, as a result, the low MW fragment component was bigger for US-CMLs derived from lignin B rather than from lignin A.

For lignin B, oligomerization did not occur under any of the conditions tested whereas lignin A is more prone to fragmentation and, therefore, it tends to oligomerize to MWs higher than 25 000 Da if the amount of capping agent added is not enough. In samples prepared with the standard method, no fragmentation or oligomerization occurred.

For the samples prepared under ultrasonic irradiation with no thermal control, lignin A oligomerized when using a SCA/lignin ratio of 3 (CAU1) and 6 (CAU2) whereas a ratio of 12 (CAU3) capped all the reactive hydroxy groups generated during the process. On the contrary, for CMLs prepared at a controlled temperature of 40° C. (CAUT1, CAUT2, CAUT3), oligomerization to high MW only occurred with a SCA/lignin ratio of 12.

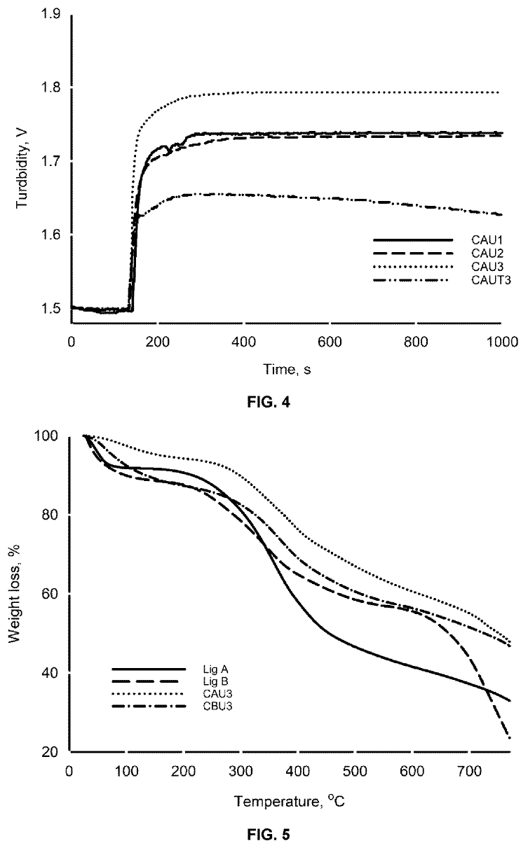

Despite CAU1 and CAU2 underwent oligomerization and had about 4% of high MW fragments (>28 000 Da), they dispersed better than CBU1 and CBU2, which were more fragmented. Without being bound to theory, this ascribes to the fact that a low percentage of high MW oligomers promotes dispersion by steric hindrance rather than by electrostatic and Van der Waals interactions. However, in the case of CAUT3, more than 8% oligomerized. As a result, the concentration of oligomers chemisorbed onto clay particles was too high and the frequency of chain interactions increased thus making the system more dense. This promoted aggregation rather than sustaining the dispersion of the water-kaolin clay slurry. In fact, PDA confirmed that the DC voltage of CAUT3 decreased over time, sign that agglomeration occurs (FIG. 4).

### Thermogravimetric Analysis

Lignin A and lignin B lost 67% and 80% of their starting weight, respectively, with the rest being ashes and impurities coming from the pulping and delignification process. The predominant weight loss occurred between 250° C. and 500° C., reaching a maximum at 350° C. when most polyaromatics degrade to CO and CO₂ [41].

Lignin B, however, had a major weight loss after 600° C. Without being bound to theory, that relates to the fact that lignin B contains a non-negligible amount of sodium (Table 1) that may increase the enthalpy of evaporation of a component with respect to the lignin in hydrogen form.

The presence of the carboxymethyl group in modified lignins induces the formation of short range interactions (H-bonds) and the entanglement of the polymeric chains, which fold on themselves and become less prone to vaporization. In fact, the weight loss of CMLs was slower and less steep than untreated lignins (FIG. 5).

All carboxymethylated lignins lost from 50% up to 65% of their weight in a temperature range of 300° C. to 400° C. and 250° C. to 500° C. in the case of lignin A and lignin B, respectively.

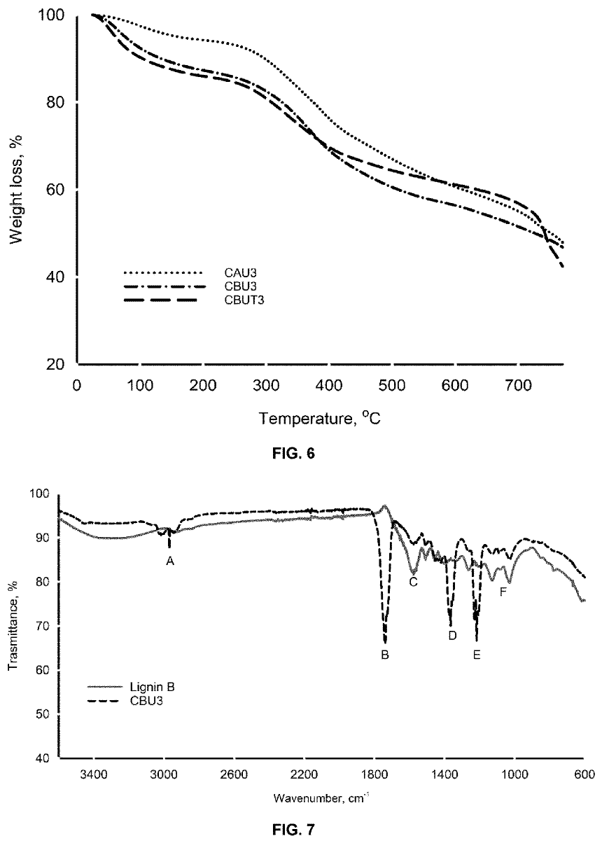

The best performing samples in term of dispersion had a similar profile but CAU3 degraded slower than CBU3 (FIG. 6). Without being bound to theory, this ascribes to the fact that CAU3 has a predominant MW component in the range of 4000 Da whereas the one of CBU3 is in the range of 2000 Da. As a consequence, CBU3 weight loss was more rapid.

### FT/IR ATR

Untreated lignins had a characteristic peak at 1575 cm⁻¹ (peak C, FIG. 7) representing the aryl and conjugated aryl groups of lignin [42]. Its intensity significantly reduced after carboxymethylation, especially for samples produced under ultrasonic irradiation. Moreover, untreated lignins and CMLs synthesized with the standard method had stronger C—O—C bond signals from 1030 cm⁻¹ to 1125 cm⁻¹ than CMLs produced with ultrasound (peak F, FIG. 7).

All CMLs had an intense peak at 1737 cm⁻¹, characteristic of the stretching of esters' C═O bond, which was not present in untreated lignins (peak B, FIG. 7).

The alkali treatment cleaved the β-O-4 aryl-ether bonds thus freeing the cinnamic building blocks of lignin and increasing the phenolic content. Part of the coumaryl, coniferyl, and sinapyl alcohols formed after the cleavage, rearranged to the corresponding cinnamic aldehyde [38]. In fact, CMLs presented a sharp but not intense signal at 3015 cm⁻¹ and 2970 cm⁻¹ (peak A, FIG. 7), which corresponds to the stretching of the C—H of the ethenyl group and methyl group of cinnamic aldehydes, respectively [43].

Carboxymethylated lignins also featured two intense peaks, one from 1240 cm⁻¹ to 1220 cm⁻¹ (peak E, FIG. 7), which indicates the presence of syringol rings and the stretching of C—O bond of the carboxymethyl ester group [44], and the second one at 1365 cm⁻¹ (peak D, FIG. 7), which represents the bending of the phenolic OH group.

FT-IR analyses confirmed that ultrasonic irradiation enhances lignin depolymerization by targeting the more labile β-O-4 linkages.

### Solubility and Particle Charge Density

Lignin B and the CMLs produced with the traditional method (CB1, CB2, CB3) were 100% soluble in water at neutral pH. The carboxymethylation under ultrasonic irradiation reduced solubility but increased charge density. For the best performing sample CBU3, the charge density increased from 1.75 m_{eq}/g to 1.93 m_{eq}/g but its solubility decreased by 87% at pH 7 and solubilized completely at pH 10. For CBUT1, the charge density reached 2.02 m_{eq}/g but only 9% was soluble at neutral pH.

Less than 2% of lignin A was soluble in water at pH 7 and carboxymethylation improved its solubility at all the condition tested. For traditional CMLs, a SCA/lignin ratio of 12 increased solubility from 1.87% to 9.21% and the charge density from 0.62 m_{eq}/g to 0.77 m_{eq}/g. For CMLs manufactured under ultrasonic irradiation, whether at controlled or uncontrolled temperature, a SCA/lignin ratio of 3 yielded the highest solubility of 10.23% and 12.39% for CAU3 and CAUT3, respectively. The solubility of the best dispersing sample (CAU3) increased by 8% but the charge density decreased from 0.62 m_{eq}/g to 0.57 m_{eq}/g.

Ultrasonic irradiation intensified the carboxymethylation reaction of softwood LignoForce Kraft lignin by shortening the reaction time from 4 h to 30 min and yielding biodispersing agents with superior performance than the ones produced via the standard method. Ultrasound enhanced the depolymerization of lignin by selectively cleaving the β-O-4 linkages, as confirmed by GPC and FT-IR analyses. Ultrasonication at 20 W and 20 kHz yielded carboxymethylated lignin with dispersing ability comparable to a common dispersant (DOSS) when produced at 70° C. to 75° C. and with a SCA/lignin ratio of 12.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

### REFERENCES

[1] GrandViewResearch, Lignin market size, share & trends analysis report by product (ligno-sulphonates, Kraft, Organosolv), by application (macromolecule, aromatic), by region (APAC, MEA, North America, Europe), and segment forecasts, 2019-2025, Market Research Report.
[2] J.-K. Weng, C. Chapple, The origin and evolution of lignin biosynthesis., The New Phytologist 187 2 (2010) 273-285.
[3] A. G. Norman, Constitution and biosynthesis of lignin. K. Freudenberg and A. C. Neish. Springer-Verlag, New York, Molecular Biology, Biochemistry and Biophysics, vol. 2, Science 165 (3895) (196) 784.
[4] E. Sjostrom, Wood Chemistry-Fundamentals and Applications, Academic Press, San Diego.
[5] K. Sarkanen, C. Ludwig, Lignins: Occurrence, formation, structure and reactions, John Wiley & Sons, Inc. New York, 1971.
[6] A. T. Austin, C. L. Ballare, Dual role of lignin in plant litter decomposition in terrestrial ecosystems, Proceedings of the National Academy of Sciences 107 (10) (2010) 4618-4622.
[7] T. Higuchi, Wood Research No. 66, 1980.
[8] R. Vanholme, B. Demedts, K. Morreel, J. Ralph, W. Boerjan, Lignin biosynthesis and structure, Plant Physiology 153 (3) (2010) 895-905.
[9] P. Bajpai, Value-Added Products from Lignin, Springer Singapore, 2018, pp. 561-571.
[10] J. Li, G. Henriksson, G. Gellerstedt, Lignin depolymerization/repolymerization and its critical role for delignification of aspen wood by steam explosion, Bioresource Technology 98 (16) (2007) 3061-3068.
[11] G. A. A. Empire Technology Development LLC, Lignin-based multipurpose fertilizers, U.S. Pat. No. 9,030,803 B2 (2015).
[12] G. L. Catignani, M. E. Carter, Antioxidant properties of lignin, Journal of Food Science 47 (5) (1982) 1745-1745.
[13] H. Chen, Lignocellulose biorefinery feedstock engineering, in: H. Chen (Ed.), Lignocellulose Biorefinery Engineering, Woodhead Publishing, 2015, pp. 37-86.
[14] W. Yang, H. Mu, Y. Huang, Treatment of black liquor from the papermaking industry by acidification and reuse, Journal of Environmental Science 15 (5) (2003) 697-700.
[15] D. Daniel, L. Khachatryan, C. Astete, R. Asatryan, C. Marculescu, D. Boldor, Sulfur contaminations inhibit depolymerization of kraft lignin, Bioresource Technology Reports 8 (2019) 100341.
[16] L. Kouisni, A. Gagn′ e, K. Maki, P. Holt-Hindle, M. Paleologou, Lignoforce system for the recovery of lignin from black liquor: Feedstock options, odor profile, and product characterization, ACS Sustainable Chemistry & Engineering 4 (10) (2016) 5152-5159.
[17] R. Sun, J. Tomkinson, F. C. Mao, X. F. Sun, Physicochemical characterization of lignins from rice straw by hydrogen peroxide treatment, Journal of Applied Polymer Science 79 (4) (2001) 719-732.
[18] C. Schuerch, The solvent properties of liquids and their relation to the solubility, swelling, isolation and fractionation of lignin, Journal of the American Chemical Society 74 (20) (1952) 5061-5067.
[19] P. Maziero, M. de Oliveira Neto, D. Machado, T. Batista, C. C. S. Cavalheiro, M. G. Neumann, A. F. Craievich, G. J. de Moraes Rocha, I. Polikarpov, A. R. Goncalves, Structural features of lignin obtained at different alkaline oxidation conditions from sugarcane bagasse, Industrial Crops and Products 35 (1) (2012) 61-69.
[20] A. R. Goncalves, P. Benar, Hydroxymethylation and oxidation of organosolv lignins and utilization of the products, Bioresource Technology 79 (2001) 103-111.
[21] L. Gan, M. Zhou, D. Yang, X. Qiu, Preparation and evaluation of carboxymethylated lignin as dispersant for aqueous graphite suspension using turbiscan lab analyzer, Journal of Dispersion Science and Technology 34 (5) (2013) 644-650.
[22] K. Bahrpaima, P. Fatehi, Synthesis and characterization of carboxyethylated lignosulfonate, ChemSusChem 11 (17) (2018) 2967-2980.
[23] M. K. Konduri, F. Kong, P. Fatehi, Production of carboxymethylated lignin and its application as a dispersant, European Polymer Journal 70 (2015) 371-383.
[24] W. Gao, J. P. W. Inwood, P. Fatehi, Sulfonation of phenolated kraft lignin to produce water soluble products, Journal of Wood Chemistry and Technology 39 (4) (2019) 225-241.
[25] W. Gao, J. P. Inwood, P. Fatehi, Sulfonation of hydroxymethylated lignin and its application, Journal of Bioresources and Bioproducts 4 (2) (2019) 80-88.
[26] X. Ouyang, K. Lixuan, Q. Xueqing, Y. Guo, Y. Pang, Sulfonation of alkali lignin and its potential use in dispersant for cement, Journal of Dispersion Science and Technology-J DISPER SCI TECH 30 (2009) 1-6.
[27] S. Lotfi, D. C. Bo to, G. S. Patience, Gas-solid conversion of lignin to carboxylic acids, React. Chem. Eng. 1 (2016) 397-408.
[28] S. Lotfi, D. C. Bo to, G. S. Patience, Gas-phase partial oxidation of lignin to carboxylic acids over vanadium pyrophosphate and aluminum-vanadium-molybdenum, ChemSusChem 8 (20) (2015) 3424-3432.
[29] P. J. e. a. Deuss, Metal triflates for the production of aromatics from lignin, ChemSusChem 9 (20) (2016) 2974-2981.
[30] A. K. Deepa, P. L. Dhepe, Lignin depolymerization into aromatic monomers over solid acid catalysts, ACS Catalysis 5 (1) (2015) 365-379.
[31] M. Fache, B. Boutevin, S. Caillol, Vanillin production from lignin and its use as a renewable chemical, ACS Sustainable Chemistry & Engineering 4 (1) (2016) 35-46.
[32] N. Khwanjaisakun, S. Amornraksa, L. Simasatitkul, P. Charoensuppanimit, S. Assabumrungrat, Techno-economic analysis of vanillin production from kraft lignin: Feasibility study of lignin valorization, Bioresource Technology 299 (2020) 122559.
[33] P. F. Britt, A. Buchanan, K. B. Thomas, S.-K. Lee, Pyrolysis mechanisms of lignin: surface-immobilized model compound investigation of acid-catalyzed and free-radical reaction pathways, Journal of Analytical and Applied Pyrolysis 33 (1995) 1-19.
[34] X. Chen, S. Li, Z. Liu, Y. Chen, H. Yang, X. Wang, Q. Che, W. Chen, H. Chen, Pyrolysis characteristics of lignocellulosic biomass components in the presence of CaO, Bioresource Technology 287 (2019) 121493.
[35] Y. Luo, Comprehensive Handbook of Chemical Bond Energies, CRC Press, Boca Raton.
[36] J.-b. Huang, S.-b. Wu, H. Cheng, M. Lei, J.-j. Liang, H. Tong, Theoretical study of bond dissociation energies for lignin model compounds, Journal of Fuel Chemistry and Technology 43 (4) (2015) 429-436.
[37] E. Dorrestijn, L. J. Laarhoven, I. W. Arends, P. Mulder, The occurrence and reactivity of phenoxyl linkages in lignin and low rank coal, Journal of Analytical and Applied Pyrolysis 54 (1) (2000) 153-192.
[38] O. Derkacheva, D. Sukhov, Investigation of lignins by FTIR spectroscopy, Macromolecular Symposia 265 (1) (2008) 61-68.
[39] V. M. Roberts, et al., Towards quantitative catalytic lignin depolymerization, Chemistry-A European Journal 17 (21) (2011) 5939-5948.
[40] PDA 3000 particle and flocculation monitor-Operating manual, Rank Brothers Ltd.
[41] M. Zhang, F. L. Resende, A. Moutsoglou, D. E. Raynie, Pyrolysis of lignin extracted from prairie cordgrass, aspen, and kraft lignin by PY-GC/MS and TGA/FTIR, Journal of Analytical and Applied Pyrolysis 98 (2012) 65-71.
[42] M. Traor' e, J. Kaal, A. M. Cortizas, Application of FTIR spectroscopy to the characterization of archeological wood., Spectrochimica acta. Part A, Molecular and biomolecular spectroscopy 153 (2016) 63-70.
[43] P. Bock, N. Gierlinger, Infrared and Raman spectra of lignin substructures: Coniferyl alcohol, abietin, and coniferyl aldehyde, Journal of Raman Spectroscopy 50 (6) (2019) 778-792.
[44] J. Reyes-Rivera, T. Terrazas, Lignin analysis by HPLC and FTIR, Vol. 1544, 2017, pp. 193-211.

1. A process for modifying lignin, said process comprising:
treating lignin material in a basic aqueous solution to obtain a mixture;
submitting the mixture to ultrasonic treatment in the presence of at least one carboxyalkylating agent to depolymerize and carboxyalkylate at the same time the lignin to obtain carboxyalkylated oligomeric lignin.

2. A process for the manufacture of a biodispersant, said process comprising:
submitting lignin material to ultrasonic treatment in the presence of a basic aqueous solution and at least one carboxyalkylating agent to depolymerize and carboxyalkylate at the same time the lignin to obtain carboxyalkylated oligomeric lignin;
recovering the carboxyalkylated oligomeric lignin as the biodispersant.

3. The process of claim 1, wherein the lignin material is softwood-derived lignin, kraft lignin, organosolv lignin, LignoForce™ lignin, LignoBoost™ lignin, hardwood-derived lignin, lignin-containing agricultural waste, lignin-containing industrial waste, or mixtures thereof.

4. The process of claim 1, wherein the lignin material has a molecular weight of about 0.4 kDa to about 30 kDa.

5. (canceled)

6. The process of claim 1, wherein the basic aqueous solution has a concentration from about 0.2M to about 3M.

7-8. (canceled)

9. The process of claim 1, wherein the treating is conducted at a temperature of about 35° C. to about 90° C.

10. The process of claim 1, wherein treating comprises sonication mixing, heating, or a combination thereof both.

11. The process of claim 1, wherein the at least one carboxyalkylating agent is selected from an alkali and alkaline earth metal salt of a C₂-C₁₀ halocarboxylic acid.

12-13. (canceled)

14. The process of claim 1, wherein the at least one carboxyalkylating agent is selected from sodium chloroacetate, sodium bromoacetate, sodium iodoacetate, sodium fluoroacetate, potassium chloroacetate, potassium bromoacetate, potassium iodoacetate, potassium fluoroacetate, sodium chloropropanoate, sodium bromopropanoate, sodium iodopropanoate, sodium fluoropropanoate, potassium chloropropanoate, potassium bromopropanoate, potassium iodopropanoate, potassium fluoropropanoate, sodium chlorobutanoate, sodium bromobutanoate, sodium iodobutanoate, sodium fluorobutanoate, potassium chlorobutanoate, potassium bromobutanoate, potassium iodobutanoate, potassium fluorobutanoate, sodium chloropentanoate, sodium bromopentanoate, sodium iodopentanoate, sodium fluoropentanoate, potassium chloropentanoate, potassium bromopentanoate, potassium iodopentanoate, and potassium fluoropentanoate.

15. (canceled)

16. The process of claim 1, wherein the ultrasonic treatment comprises applying ultrasound at a frequency of about 20 kHz to about 100 kHz.

17. The process of claim 1, wherein the ultrasonic treatment comprises applying ultrasound with a nominal power of about 0.5 kW to about 5 kW.

18. The process of claim 1, wherein the ultrasonic treatment comprises applying ultrasound with a nominal power of about 6 kW to about 16 kW.

19. The process of claim 1, wherein the ultrasonic treatment comprises applying ultrasound through a surface of about 0.1 cm² to about 10 cm² with a nominal power of about 0.5 kW to about 5 kW.

20. The process of claim 1, wherein the ultrasonic treatment comprises applying ultrasound through internal or external emitter and through a surface of about 2.5 cm² to about 450 cm² with a nominal power of about 6 kW to about 16 kW.

21. The process of claim 1, wherein the ratio of power by surface for the ultrasonic treatment is from about 0.05 to about 50 kW/cm².

22. The process of claim 1, wherein the ratio of power by surface for the ultrasonic treatment is from about 6.4 to about 90 kW/cm².

23-29. (canceled)

30. A process for selective breakage of aryl ether linkages of lignin, said process comprising:
treating raw lignin material in a basic aqueous solution at a temperature of about 35° C. to about 90° C. to obtain a mixture;
submitting the mixture to ultrasonic treatment at a frequency of about 20 kHz to about 100 kHz in the presence of at least one carboxymethylating agent to depolymerize and carboxymethylate the lignin to obtain carboxymethylated oligomeric lignin;
wherein the basic aqueous solution comprises NaOH, KOH, LiOH, Ca(OH)₂, or mixtures thereof;
wherein the carboxymethylating agent is selected from sodium chloroacetate, sodium bromoacetate, sodium iodoacetate, sodium fluoroacetate, potassium chloroacetate, potassium bromoacetate, potassium iodoacetate and potassium fluoroacetate.

31-45. (canceled)

46. The process of claim 11, wherein the alkali and alkaline earth metal salt is selected from sodium salt, potassium salt, lithium salt, calcium salt, magnesium salt, and mixtures thereof.

47-50. (canceled)
